(19) United States
(12) Patent Application Publication
(10) Pub. No.: US 2009/0289457 A1
(43) Pub. Date: Nov. 26, 2009

(54) HYDROGEN POWERED STEAM TURBINE

(75) Inventor: James Y. Gleasman, Rochester, NY (US)

Correspondence Address: MORTON A. POLSTER;BROWN & MICHAELS, P.C., 400 M & T BANK BUILDING, 118 N. TIOGA STREET, ITHACA, NY, 14850, US

(73) Assignee: TORVEC, INC., Rochester, NY (US)

(21) Appl. No.: 12/504,226

(22) Filed: Jul. 16, 2009

Related U.S. Application Data
(63) Continuation-in-part of application No. 12/238,974, filed on Sep. 26, 2008.
(60) Provisional application No. 60/975,665, filed on Sep. 27, 2007.

(51) Int. Cl. H02K 7/18; F01K 15/00; F01K 13/00

(52) U.S. Cl. 290/52; 60/670; 60/645

(57) ABSTRACT

A process provides energy from a hydrogen flame to produce ultra high temperature steam, which is water vapor having a temperature over 1200° C., as an energy transfer medium to drive a steam turbine. The hydrogen fuel may be supplied to the system from a source of isolated hydrogen such as compressed or liquefied H₂, but is more preferably generated near its site of combustion, e.g., by irradiating an aqueous solution of one or more inorganic salts or minerals with radiofrequency electromagnetic radiation having a spectrum and intensity selected for optimal hydrogen production. The ultra high temperature steam is produced by contacting the hydrogen flame and its combustion gases with surfaces in a ceramic steam generation unit. In one embodiment, a radiofrequency generator produces hydrogen gas from sea water to provide hydrogen fuel to produce steam to drive the turbine.

### REFERENCE TO RELATED APPLICATIONS

This is a continuation-in-part of co-pending patent application Ser. No. 12/238,974, filed Sep. 26, 2008, entitled “HYDROGEN POWERED STEAM TURBINE”, which claims priority to Provisional Application No. 60/975,665, filed Sep. 27, 2007, entitled “HYDROGEN POWERED STEAM TURBINE”. The aforementioned applications are hereby incorporated herein by reference.

### BACKGROUND OF THE INVENTION

1. Field of the Invention

The invention pertains to the field of energy generation. More particularly, the invention pertains to a system for converting gaseous hydrogen fuel to electricity.

2. Description of Related Art

There is increasing interest in the use of hydrogen gas as a fuel. Hydrogen is potentially plentiful, and since water is the only by-product of its combustion, it is the cleanest burning of all fuels. Fossil fuels, meanwhile, are increasingly scarce and expensive, and an increasing awareness of global warming, air pollution, and other undesirable effects of burning carbon-based fuels make their continued use problematic.

Hydrogen gas (H₂) burns with intense heat. In air, hydrogen burns with a flame temperature of 2045° C. In contrast, methane (natural gas) burns at only 1325° C. Hydrogen can therefore be used to produce steam at a higher temperature than is achievable with fossil fuel fired boilers.

One challenge associated with hydrogen fuel is the fact that hydrogen—though abundant on earth—does not occur in its elemental form H₂ in any useful quantity. As such, in order to utilize hydrogen as a fuel it must be manufactured. This is most commonly done by steam reformation of methane (the syngas process) or electrolysis of water. It presently takes more energy to produce H₂ than is obtained by burning the gas. Recently, several new processes hold promise that the production of hydrogen can be made more efficient. These new processes include, among others, processes where one or more generation activators are used to produce hydrogen from aqueous solutions, e.g., (1) adding water to a generation activator comprising an alloy of aluminum and gallium, discovered by Jerry Woodall at Purdue University as disclosed on May 16, 2007 in Technology/Engineering, on Mar. 6, 2009 in U.S. Patent Application Publication 2008/0056986, and on Mar. 13, 2009 in U.S. Patent Application Publication 2008/0063597; (2) utilizing radio frequency electromagnetic radiation as a generation activator, e.g., (a) using radiant energy dissociation of water to form hydrogen, as disclosed in U.S. Patent Application Publication 2005/0029120, and (b) using a radiofrequency transmitter, as described in International Publication No. WO 2005/120639, by John Kanzius et al., published Dec. 22, 2005 (details of the process are also disclosed in “Salt Water Can ‘Burn,’ Scientist Confirms” by John Roach, Nation Geographic News, Sep. 14, 2007). These publications are incorporated herein by reference.

### SUMMARY OF THE INVENTION

The present invention is directed to a process for producing energy from a hydrogen flame. The process relies on ultra high temperature steam, which is water vapor having a temperature over 1200° C., as an energy transfer medium. The hydrogen fuel is preferably generated near its site of combustion. In one embodiment, such generation is accomplished by irradiating a water solution of one or more inorganic salts or minerals with radio frequency electromagnetic radiation at a frequency and intensity selected to maximize the production of combustible hydrogen per unit of electromagnetic energy input to the system. Once the hydrogen is generated, ultra high temperature steam is produced by contacting the hydrogen flame and its combustion gases with heat exchange surfaces in a ceramic steam generation unit. The ultra high temperature steam is used as an energy transfer medium to drive one or more steam turbines. The steam turbines may be coupled to an electrical generator, a vehicular drive, or any similar application to which turbine power is typically coupled. In a preferred embodiment of the present invention, the steam driven turbine is coupled to a radiofrequency generator capable of producing hydrogen gas from sea water.

### BRIEF DESCRIPTION OF THE DRAWINGS

FIG. 1 shows a block diagram of a preferred embodiment of the present invention.

FIG. 2 shows an increase in the thermal conductivity of zirconia with increasing temperature.

### DETAILED DESCRIPTION OF THE INVENTION

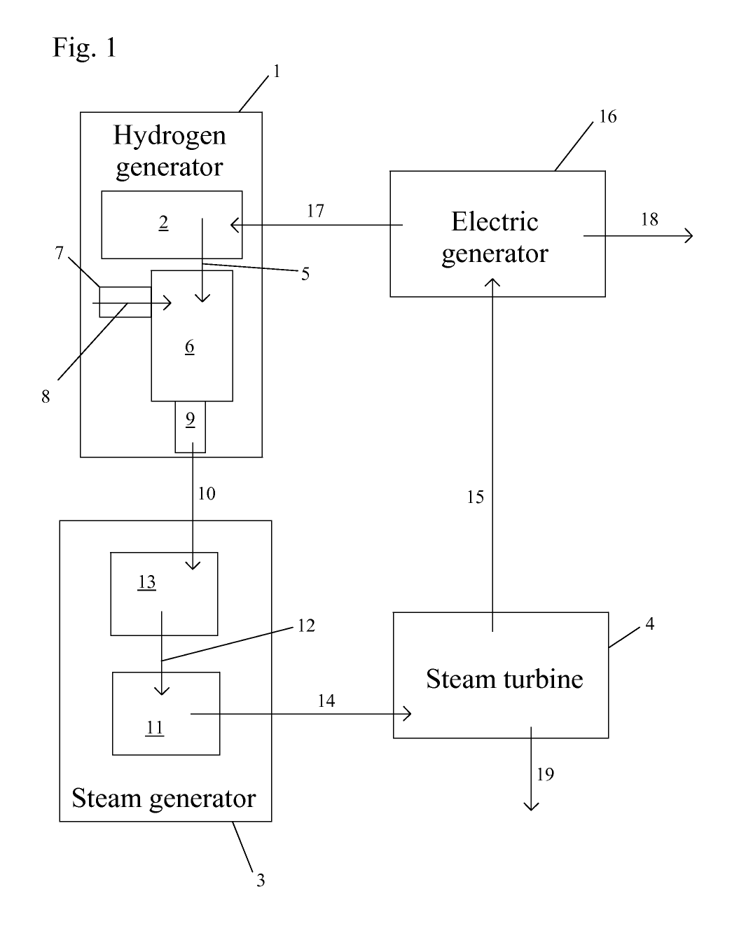

Referring to FIG. 1, an apparatus of the present invention preferably includes three main components: a hydrogen generator 1, a hydrogen-fired ultra high temperature steam generator 3, and a steam turbine 4. The steam turbine is driven by ultra high temperature steam which is generated by contacting liquid water or steam with the heat generated by burning hydrogen from the hydrogen generator. Ultra high temperature steam for the purposes of the present invention is defined as water vapor having a temperature above 1200° C.

### Hydrogen Generation

Hydrogen gas (H₂) is currently produced commercially from hydrocarbons (via syngas) or from water (via electrolysis). Each of these processes is energy-intensive and relatively inefficient. Although hydrogen may be generated by any process within the spirit of the present invention, a preferred hydrogen generation process for the present invention relies on a generation activator to generate hydrogen gas from water. The hydrogen generator 1 preferably includes a generation activator 2, a reservoir 6 containing water, a reservoir inlet 7 for makeup water 8, and a hydrogen gas outlet 9. The temperature of the water in the reservoir 6 is preferably monitored and maintained at a temperature below its boiling point.

The water in the hydrogen generator 1 is preferably part of an aqueous electrolyte solution containing dissolved ions. Preferably the ions are provided by one or more inorganic salts. More preferably, the electrolyte includes halides of alkali metals, and still more preferably the electrolyte includes sodium chloride. One specific electrolyte solution particularly suitable for the methods and processes of the present invention is natural sea water.

A preferred hydrogen generation process for the present invention relies on irradiation of aqueous solutions of inorganic salts to liberate hydrogen. Laboratory scale experiments have demonstrated that a combustible hydrogen-containing gas can be generated directly from sea water by irradiation with radio frequency radiation of appropriate wavelength and intensity. In this embodiment, the generation activator 2 is a radiofrequency generator irradiating the water with radio frequency radiation 5.

In another embodiment of the present invention, the generation activator 2 is an alloy of aluminum and gallium in solid pellet form that produces hydrogen gas from water when placed in contact with the water as disclosed in U.S. Patent Application Publication 2008/0056986. The alloy preferably contains 20-80 weight % aluminum and 20-80 weight % gallium. When the alloy is exposed to water, hydrogen gas is generated as the aluminum in the alloy is oxidized by the water. In some embodiments the solid pellet aluminum/gallium alloy is used with a liquid alloy of gallium and indium to enhance hydrogen production. The liquid alloy inhibits the passivation caused by formation of aluminum oxide during hydrogen generation. The liquid alloy preferably contains about 80 weight % gallium and about 20 weight % indium.

In a preferred embodiment, the hydrogen generator operates in a ‘flow-through’ mode where electrolyte solution flows through the hydrogen generator. Such a flow-through design is particularly convenient if a plentiful source of sea water is available. If the flow is maintained at a sufficient rate, then no additional cooling of the electrolyte solution is required. A preferred embodiment of the invention couples this hydrogen generation process directly with an ultra high temperature steam generation unit.

### Radio Frequency Source

When the generation of hydrogen utilizes radio frequency, the radio frequency source 2 must be able to provide an output 5 with a frequency spectrum appropriate to generate hydrogen from the specific electrolyte being used, and must have sufficient output wattage to generate hydrogen at a rate matched to the consumption rate of the burner in the steam generator 3. Preferably the radio frequency source 2 is tunable to allow optimization of hydrogen production with various salt solutions. More preferably, the radio frequency source has an output tunable over the frequency range from about 300 MHz to about 1000 GHz. Preferably the radio frequency source 2 has a variable output intensity so that the rate of hydrogen flow from the generator may be modulated.

The hydrogen gas 10 produced by the generator may optionally be combusted immediately upon generation. Thus, in a preferred embodiment, the headspace above the electrolyte bath is continuous with one of more hydrogen combustion chambers of the steam generator 3. In this way, there is no requirement to isolate or transfer the hydrogen gas prior to combustion. In designs of this type, heating of the electrolyte bath by radiant energy from the burner is preferably minimized. In one embodiment a hydrogen-porous insulating material is located on or near the surface of the electrolyte solution to minimize heat transfer to the bath.

### Steam Generation

Prior art boilers are generally not compatible with temperatures in excess of about 700° C. This limitation is due primarily to the fact that the materials from which boilers are constructed are not compatible with higher temperatures.

Boilers 11 of the present invention are preferably constructed of high temperature refractory ceramics capable of withstanding hydrogen flame temperatures (e.g. at least 2000° C.). Ceramic compositions suitable for constructing boiler components of the present invention include, but are not limited to, aluminum oxide, aluminum titanate, zirconium oxide, zirconia (ZrSiO₄), silicon dioxide, magnesium oxide, yttrium oxide, silicon carbide, silicon nitride, silicon aluminum oxinitride (sialon), tungsten carbide, boron nitride, as well as composites and mixtures of the above materials.

The ultra high temperature steam is generated by thermally coupling 12 a source of liquid water or steam to the hydrogen flame of the burner 13. Where steam is the feed stream heated by the hydrogen flame, it may be provided by a lower temperature steam generator and then heated by the hydrogen flame to increase its temperature to at least 1200° C. The steam fed to the hydrogen-fired boiler may also be generated by contacting spent stream from the exhaust of a turbine driven by ultra high temperature steam with feed water such that the water is vaporized. In another embodiment, a portion of the steam may be provided directly from the water vapor formed by the combustion of the hydrogen gas. In this way, additional thermal energy from the combustion may be captured in the steam output from the generator.

The geometry of the ceramic heat exchanging elements of the boiler may be of traditional tube designs as are well known in the art. Suitable prior art boiler geometries may be found in Steam: its generation and use, S. C. Stultz and J. B. Kitto (eds.), Babcock and Wilcox Co., Barberton, Ohio 1992, which is incorporated herein by reference. More preferably, the steam generator includes a monolithic block of ceramic material having channels, in which hydrogen is combusted, interleaved with passages through which steam circulates and is heated. Preferably in this system, the entire block of ceramic material is maintained at the desired steam temperature, and the hydrogen combustion rate is modulated to balance the flow rate of steam entering the boiler.

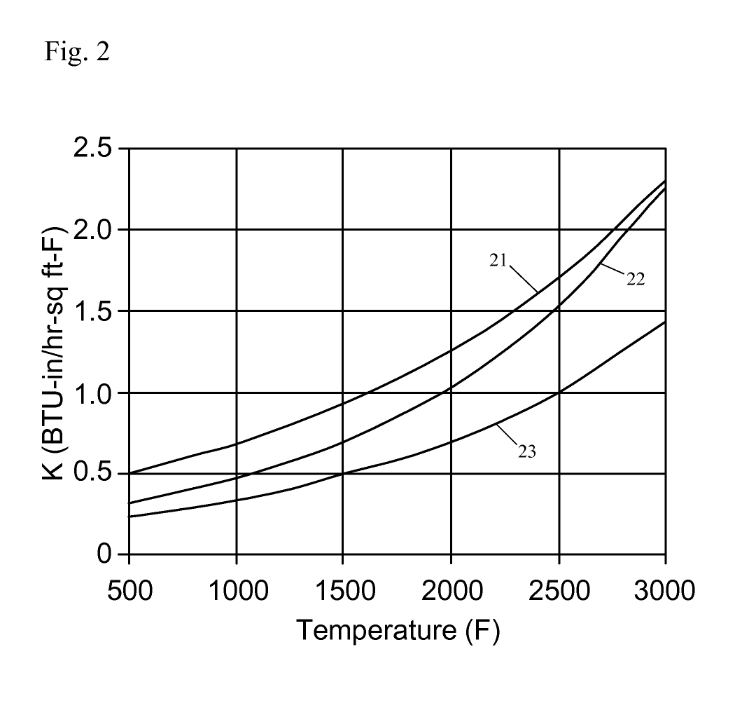

Since many ceramics increase in thermal conductivity at very high temperatures, a boiler of this design more efficiently transfers energy to the steam as the temperature of the system increases and the monolithic ceramic block becomes a more efficient conductor. Zirconium dioxide has a very low thermal conductivity at room temperature, but is an excellent thermal conductor at higher temperatures. FIG. 2 shows the thermal conductivity of zirconia in air 21, argon 22, and a vacuum 23. FIG. 2 shows that the thermal conductivity of zirconia is about 0.5 BTU-in/hr-ft²-° F. in air at 500° F. but increases to 1.25 BTU-in/hr-ft²-° F. at 2000° F., the approximate temperature of a hydrogen flame.

The steam generator may be operated at sub-critical (less than 22.1 MPa), critical (22.1 MPa), or super-critical pressures (or greater than 22.1 MPa). Normally, operation at supercritical pressures results in higher overall turbine efficiencies. Additional strategies for steam generation from hydrogen combustion which may be used in the present invention are discussed by H. Jin and M. Ishida in “A novel gas turbine cycle with hydrogen-fueled chemical-looping combustion” International Journal of Hydrogen Energy 25 (2000) 1209-1215, which is incorporated herein by reference.

### Steam Turbines

Ultra high temperature steam 14 is directed from the steam generator 3 under pressure to one or more steam turbines 4. Normally, several turbine stages are coupled in series to capture as much energy as possible from a steam source. Preferably the first stage turbine contacting the ultra high temperature steam feed from the steam generator is constructed from refractory materials able to withstand temperatures of at least 1200° C. More preferably, at least one turbine stage is capable of withstanding temperatures of at least 1500° C. The steam is at a lower temperature in any subsequent turbine stage so, depending on the design of the first stage, it may be possible to use second and third stage turbines constructed from traditional materials. A steam turbine of the present invention may be a reaction-type steam turbine or an impulse-type steam turbine. A steam turbine of the present invention may be an axial flow turbine or a radial flow turbine. The details of turbine design are well known and details of turbine designs suitable for the present invention may be found in A Practical Guide to Steam Turbine Technology by Heinz P. Bloch, 1995, which is incorporated herein by reference.

The turbine is preferably coupled 15 to an electric generator 16. The details of such generators and their coupling to turbines is well known in the prior art. Optionally, a portion of the energy output 17 from the electric generator may be coupled back to the radiofrequency source of the hydrogen generator. The remainder of the electrical energy 18 is preferably used to perform work.

Alternatively, the turbine may be coupled directly 19 to a device to perform mechanical work. A particularly suitable application of a system of the present invention is to power an ocean going vessel, since a vast supply of sea water would be available to circulate through the electrolyte chamber of the hydrogen generator. The apparatus described above may be adapted to a variety of other purposes where ultra high temperature steam, electricity, or mechanical power or a combination thereof need to be provided by a compact self-contained system.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A system for generating power comprising:
a) a hydrogen generator for generating a hydrogen fuel;
b) a steam generator comprising a burner for burning the hydrogen fuel to heat a water source, thereby generating an ultra high temperature steam; and
c) at least one steam turbine driven by the ultra high temperature steam to generate power.

2. The system of claim 1, wherein the hydrogen generator comprises:
a) a reservoir for containing water;
b) a generation activator for activating water in the reservoir;
c) an inlet for receiving additional solution in the reservoir; and
d) a hydrogen gas outlet coupled to the steam generator.

3. The system of claim 2, wherein the generation activator is an alloy of aluminum and gallium.

4. The system of claim 2, wherein the generation activator is a radio frequency generator for generating a radio frequency to be applied to the aqueous electrolyte solution.

5. The system of claim 4, wherein the radio frequency generator is operable at a wattage such that a rate of generation of the hydrogen matches a consumption rate of the hydrogen in the burner.

6. The system of claim 4, wherein the radio frequency generator is tunable such that the radio frequency is selected to maximize production of the hydrogen fuel per unit of electromagnetic energy input from the radio frequency generator.

7. The system of claim 6, wherein the radio frequency generator is tunable in a frequency range of about 300 MHz to about 1000 GHz.

8. The system of claim 2, wherein the aqueous electrolyte solution is sea water.

9. The system of claim 2, wherein the aqueous electrolyte solution is continuously flowing through the reservoir.

10. The system of claim 1, wherein the steam generator further comprises a boiler for applying heat from the burner to the water source.

11. The system of claim 10, wherein the boiler is constructed of a high temperature refractory ceramic material selected from the group consisting of aluminum oxide, aluminum titanate, zirconium oxide, zirconia, silicon dioxide magnesium oxide, yttrium oxide, silicon carbide, silicon nitride, silicon aluminum oxinitride, tungsten carbide, boron nitride, and any combination of the above materials.

12. The system of claim 1, wherein the steam turbine is coupled to an electric generator.

13. The system of claim 12, wherein the electric generator provides energy to run the radio frequency generator.

14. A method of generating power comprising the steps of:
a) generating a hydrogen fuel;
b) burning the hydrogen fuel to heat a water source to form an ultra high temperature steam; and
c) driving a steam turbine using the ultra high temperature steam.

15. The method of claim 14, wherein the step of generating the hydrogen fuel comprises the sub-step of applying a generation activator to an aqueous electrolyte solution to produce the hydrogen fuel.

16. The method of claim 15, wherein said generation activator comprises an alloy of aluminum and gallium.

17. The method of claim 15, wherein said generation activator comprises a radio frequency.

18. The method of claim 17, wherein the step of generating the hydrogen fuel further comprises the sub-step of tuning the radio frequency to maximize production of the hydrogen fuel per unit of electromagnetic energy input.

19. The method of claim 14 further comprising the step of driving an electric generator using the steam turbine.

20. The method of claim 19 further comprising the step of using the electric generator in the creation of said radio frequency.

21. The method of claim 14 further comprising the step of driving a device used to perform mechanical work using the steam turbine.
